(19) United States
(12) Patent Application Publication
(10) Pub. No.: US 2018/0368208 A1
(43) Pub. Date: Dec. 20, 2018

(54) WIRELESS ACCESS DEVICE AND LIGHTING SYSTEM INCLUDING THE SAME

(71) Applicants: LITE-ON ELECTRONICS (GUANGZHOU) LIMITED, GUANGZHOU (CN); LITE-ON TECHNOLOGY CORP., TAIPEI (TW)

(72) Inventors: MING-RU YANG, TAIPEI (TW); CHING-HSIEN LIN, TAIPEI (TW); YAO-CHUNG YEH, TAIPEI (TW)

(21) Appl. No.: 15/779,889

(22) PCT Filed: Jul. 10, 2016
(86) PCT No.: PCT/CN2016/089585

§ 371 Date: May 30, 2018

(30) Foreign Application Priority Data
Dec. 14, 2015 (CN) 201521039064.9

(51) Int. Cl. H04W 88/08; H04W 4/38; H05B 37/02; H05B 37/03

(52) U.S. Cl. CPC H04W 88/08; H04W 4/38; G01V 1/008; H05B 37/03; H05B 37/0272

(57) ABSTRACT

A wireless access device is configured to be electrically connected to a lighting device that communicates with a server. The wireless access device includes a connecting base. The connecting base includes an electrical connection interface, which is configured to be directly and electrically connected to the lighting device and to receive electric power from the lighting device. The wireless access device is configured to communicate with the server through the electrical connection interface and to receive the electric power from the lighting device through the electrical connection interface.

### CROSS-REFERENCE TO RELATED APPLICATION

This application claims priority of Chinese Application No. 201521039064.9, filed on Dec. 14, 2015.

### FIELD

The disclosure relates to a lighting system, more particularly to a lighting system including a wireless access device.

### BACKGROUND

With the development of wireless technology, users can access the internet more conveniently via wireless networks than via conventional wired networks. Because of advantages such as high mobility, quick installation, physical wire saving, relatively low setup cost, and extra network coverage of the wired network, various kinds of wireless networks have been adopted in different areas, such as wireless personal area network (WPAN), wireless local area network (WLAN), wireless metropolitan area network (WMAN) and wireless wide area network (WWAN).

In general, wireless access devices such as Access Points (APs), allow users to access the internet via the established wireless networks. Moreover, portable electronic devices, such as mobile phones and laptops using wireless technology are widely adopted by users. Therefore, to effectively increase coverage of the wireless networks may be a task for experts in the related field.

### SUMMARY

One object of the disclosure is to provide a wireless access device configured to be electrically connected to a lighting device that communicates with a server.

Another object of the present disclosure is to provide a lighting system capable of wireless communication, so that the wireless network coverage can be increased.

According to one aspect of the present disclosure, a wireless access device configured to be electrically connected to a lighting device that communicates with a server includes a connecting base. The connecting base includes an electrical connection interface, which is configured to be directly and electrically connected to the lighting device and to receive electric power from the lighting device. The wireless access device is configured to communicate with the server through the electrical connection interface and to receive the electric power from the lighting device through the electrical connection interface.

According to another aspect of the disclosure, a lighting system includes a lighting device that is configured to communicate with a server, and the aforesaid wireless access device.

### BRIEF DESCRIPTION OF THE DRAWINGS

Other features and advantages of the disclosure will become apparent in the following detailed description of the embodiments with reference to the accompanying drawings, of which:

FIG. 1 is a schematic view illustrating one exemplary embodiment of a lighting system including a lighting device and a wireless access device according to the disclosure;

FIG. 2 is a schematic block diagram of one embodiment, illustrating the relationship between the lighting device and the wireless access device;

FIG. 3 is a top plan view of one embodiment, illustrating an electrical connection interface of the wireless access device;

FIG. 4 is a schematic view of one embodiment, illustrating a connecting base of the wireless access device;

FIG. 5 is an exploded perspective view of one embodiment, illustrating the wireless access device;

FIG. 6 is a perspective view of one embodiment illustrating the wireless access device;

FIG. 7 is a schematic view of one embodiment, illustrating that the lighting system includes a monitoring device, an environment detecting device, and a notification device;

FIG. 8 is a block diagram of one embodiment, illustrating the lighting system; and

FIG. 9 is a block diagram of one embodiment, illustrating the lighting system.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

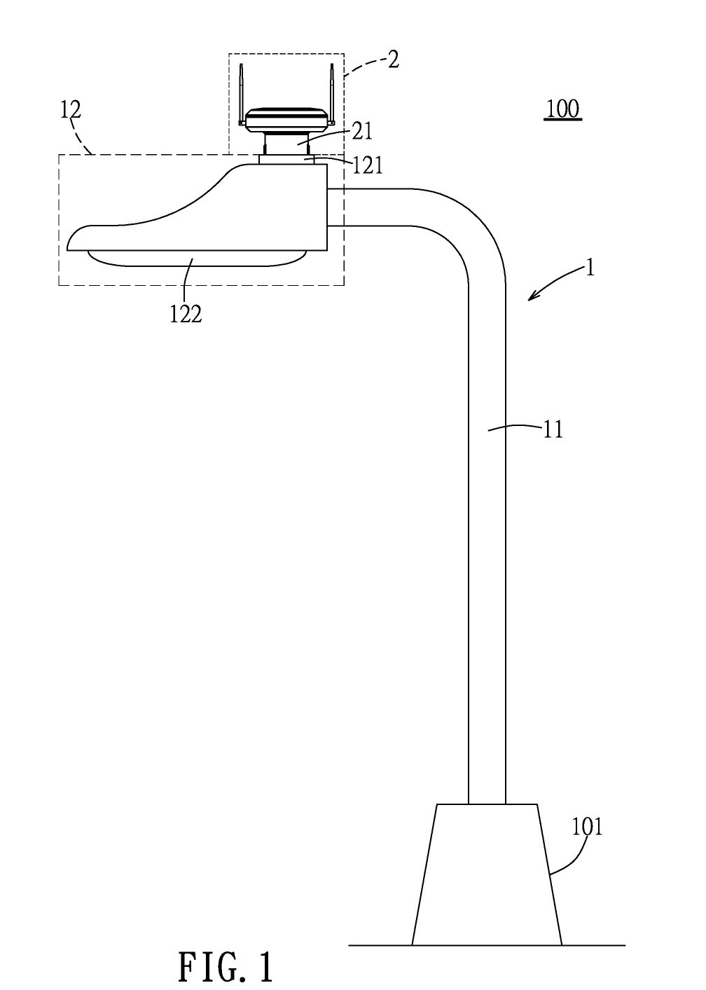

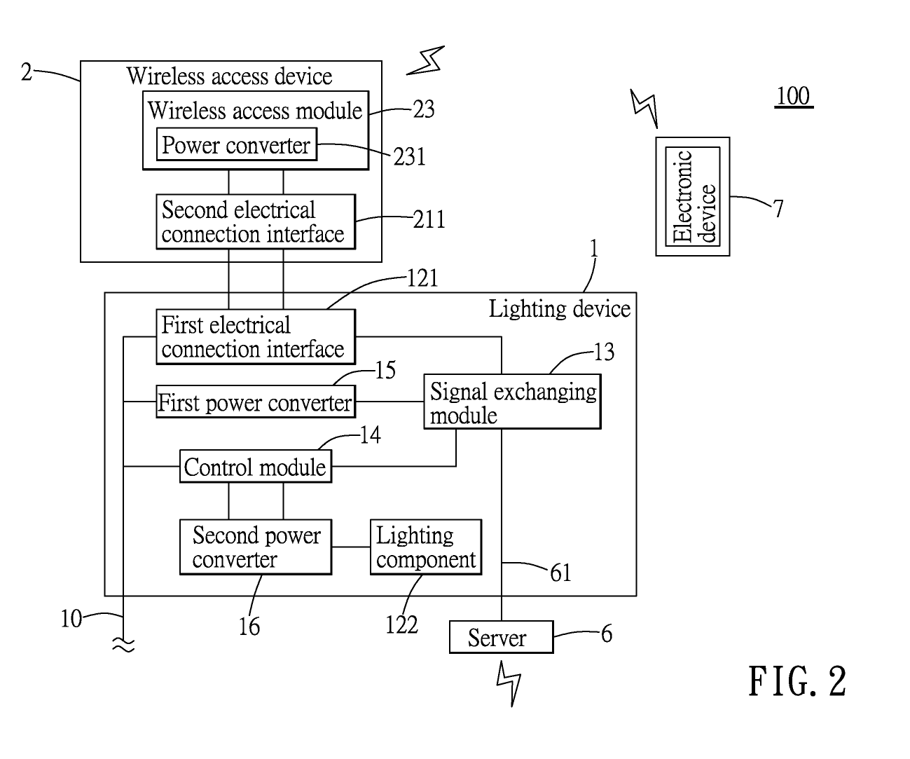

Referring to FIGS. 1 and 2, one exemplary embodiment of a lighting system 100 capable of wireless communication is illustrated and includes a lighting device 1 and a wireless access device 2. In certain embodiments, the lighting device 1 is a streetlight as illustrated in FIG. 1. However, the lighting device 1 can be any outdoor light fixture in other embodiments according to the present disclosure.

As illustrated in FIG. 1, the lighting device 1 of the exemplary embodiment may include a pole 11, a lighting module 12, and a base 101. The pole 11 has one end connected to the base 101 and the other end extending upward to support the lighting module 12. The lighting module 12 includes a first electrical connection interface 121 and a lighting component 122. The lighting component 122 may be a light bulb in certain embodiments, but can be a light emitting diode (LED) in other embodiments according to the present disclosure. The wireless access device 2 of the exemplary embodiment includes a connecting base 21 by which the first electrical connection interface 121 of the lighting device 1 and the wireless access device 2 are electrically coupled.

As shown in FIG. 2, the lighting device 1 of the exemplary embodiment is configured to communicate with a server 6 and further includes a signal exchanging module 13, a control module 14, first and second power converters 15 and 16, and a power line 10 for AC power supply. The power line 10 is electrically connected to the first electrical connection interface 121 and supplies electric power to the wireless access device 2 through the first electrical connection interface 121. The power line 10 is also electrically connected to the control module 14 and the first power converter 15. The first power converter 15 is configured to be electrically connected to the signal exchanging module 13, to convert the AC power received from the power line 10 into DC power, and to supply the DC power to the signal exchanging module 13. The control module 14 is configured to be electrically connected to the second power converter 16, which converts the AC power received from the control module 14 into DC power and supplies the DC power to the lighting component 122. The signal exchanging module 13 is configured to communicate with the server 6 and to receive a control signal from the server 6. The control module 14 is electrically connected to the signal exchanging module 13 for receiving the control signal therefrom, and is configured to control the lighting component 122 by altering the DC power outputted from the second power converter 16 in response to the control signal. In addition, the control module 14 may be further configured to send an error signal to the signal exchanging module 13 when the lighting component 122 exhibits abnormal activity, and the signal exchanging module 13 may be further configured to transmit the error signal to the server 6 upon receipt of the same, so that maintenance staff can be informed thereby and provide subsequent repair/maintenance.

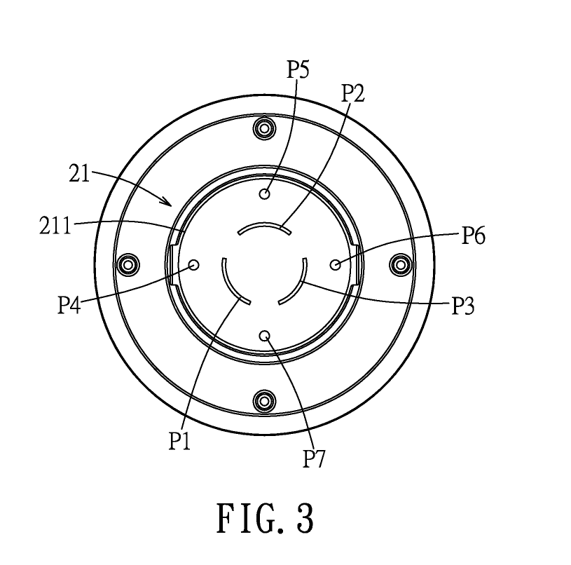

As illustrated in FIGS. 2 to 4, the connecting base 21 of the wireless access device 2 of the exemplary embodiment includes a second electrical connection interface 211, which is directly and electrically connected to the lighting device 1 to receive electric power from the lighting device 1. The second electrical connection interface 211 may include a first plurality of pins configured to transmit the electric power, and a second plurality of pins configured to transmit data. In this exemplary embodiment, both the first and second electrical connection interfaces 121 and 211 may be NEMA connectors complying with ANSI C136 standards where the second electrical connection interface 211 includes seven pins (P1, P2, P3, P4, P5, P6, P7)among which the first plurality of pins, i.e., the pins (P1, P2, P3), are configured to transmit the electric power and the second plurality of pins, i.e., the pins (P4, P5, P6, P7) are configured to transmit data. As a consequence of compatibility between the first and second electrical connection interfaces 121 and 211, it is convenient to combine the wireless access device 2 with the lighting device 1.

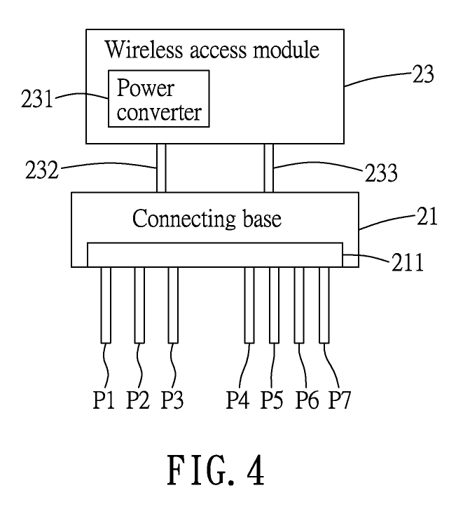

As illustrated in FIG. 4, in certain embodiments, the wireless access device 2 may further include a wireless access module 23. In such embodiments, the wireless access module 23 may include a power converter 231, a power line 232, and a data line 233. The power line 232 electrically connects the first plurality of pins of the second electrical connection interface 211 with the power converter 231 for power transmission. The data line 233 is electrically connected to the second plurality of pins of the second electrical connection interface 211 for data transmission. In other words, the wireless access module 23 is electrically connected to the second electrical connection interface 211, and is configured to communicate with the server 6 through the second electrical connection interface 211 by way of the data line 233, and to receive the electric power through the second electrical connection interface 211 by way of the power line 232. The power converter 231 is configured to convert the AC power received from the power line 232 to DC power for supplying the DC power to the wireless access module 23. The wireless access module 23 is also configured to wirelessly communicate with an electronic device 7, so as to allow the electronic device 7 to communicate with the server 6 and to transmit a message from the server 6 to the electronic device 7. That is to say, when the electronic device 7 is within the signal coverage of the wireless access device 2 and a communication channel is established, the electronic device 7 can transmit or receive data with the server 6 via the wireless access device 2 and the signal exchanging module 13 in the lighting device 1.

It may be noted that, in certain embodiments, a signal line 61 may be provided to interconnect the signal exchanging module 13 of the lighting device 1 and the server 6 as illustrated in FIG. 2. In this way, the wireless access module 23 can access the server 6 through the signal line 61. In such embodiments, the signal line 61 may be an optical fiber disposed in the pole 11.

It may be worth noting that, in this exemplary embodiment, the wireless access module 23 is a wireless access point (WAP), but the wireless access module 23 can be a wireless router in other embodiments according to the present disclosure. Owing to the relatively large coverage area of the lighting device 1, combining the wireless access device 2 therewith can not only effectively promote popularization and increase the coverage area of wireless communication, but can also reduce the traffic load of base stations from internet service providers (ISPs).

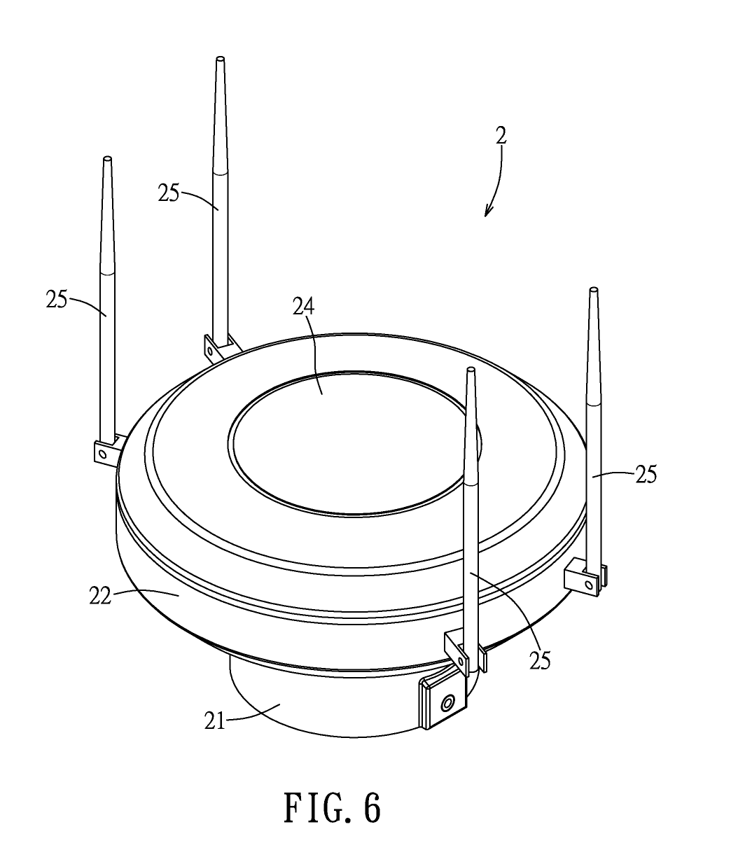

As illustrated in FIGS. 4 to 6, the wireless access device 2 may further include a housing 22, a cover 24, and at least one antenna 25 (multiple antennas are shown in the drawings) connected to and extending through the housing 22. The housing 22 is connected to the connecting base 21 and defines a receiving space 20 in which the wireless access module 23 is disposed. The cover 24 may be removably connected to the housing 22 for enclosing the receiving space 20. In certain embodiments, the housing 22 and the cover 24 maybe made of waterproof material and may be cooperatively formed into a waterproof structure to protect the wireless access module 23 received therein, e.g., to prevent the wireless access module 23 from malfunctioning due to permeation of raindrops into the receiving space 20.

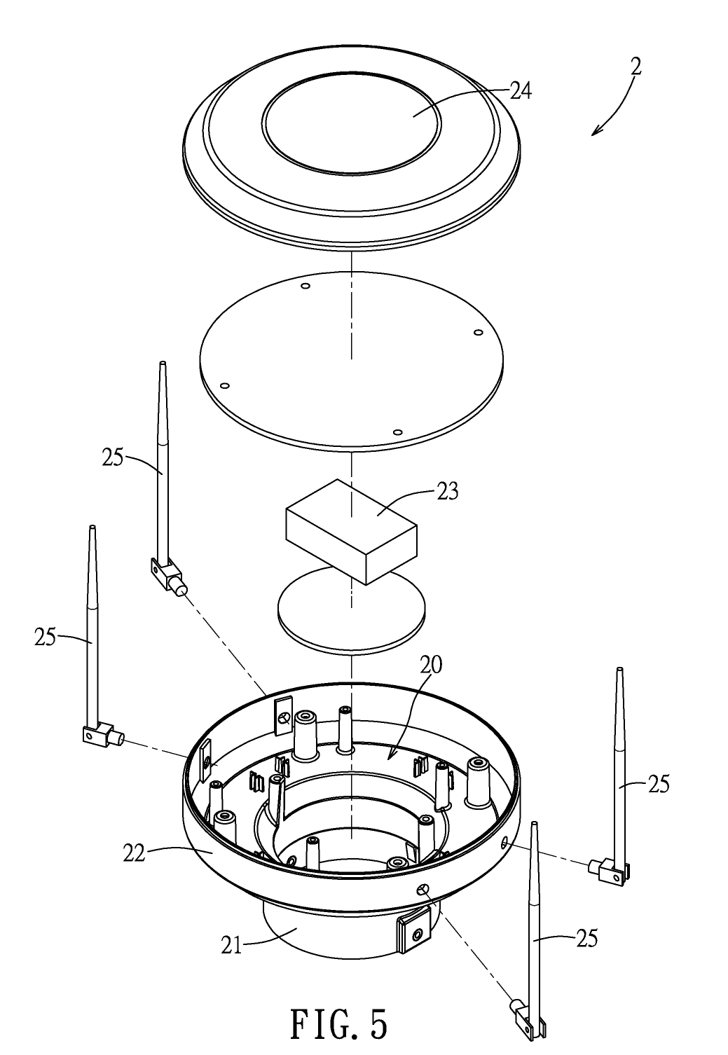

In certain embodiments, the cover 24 and the housing 22 may both be configured into a rounded shape as illustrated in FIG. 5. Such a symmetric structure allows for relatively simple assembly of the cover 24 and the housing 22. It should be noted that, the housing 22 and the cover 24 are not limited to having the rounded shape, but instead may be configured into other shapes according to the present disclosure.

In certain embodiments, the antenna 25 may be configured to provide GPS satellite navigation, long distance signal transmission, and/or short distance signal transmission, so as to allow the wireless access device 2 to perform wireless telecommunication functions. Note that in other embodiments, the antenna 25 may be configured as a hidden antenna disposed within the receiving space 20 of the housing 22.

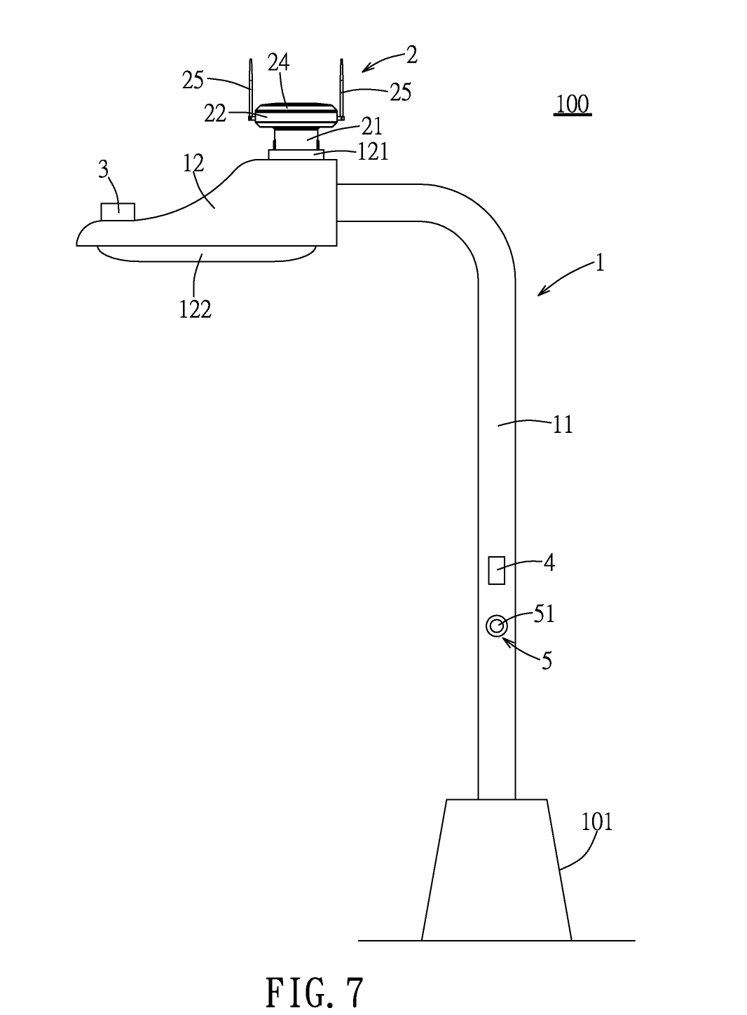

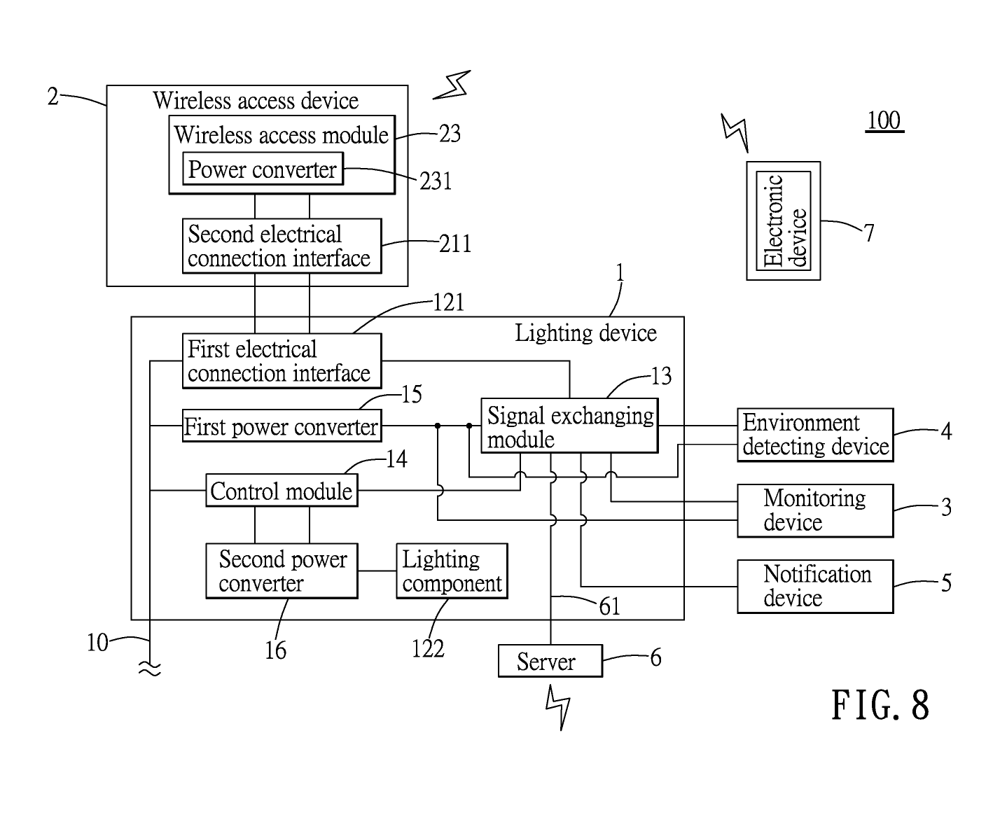

In certain embodiments, the lighting device 1 of the lighting system 100 may further include a monitoring device 3, an environment detecting device 4, and a notification device 5 as illustrated in FIGS. 7 and 8. The monitoring device 3 is electrically connected to the signal exchanging module 13 and to the first power converter 15 for receiving DC power therefrom. The monitoring device 3 may be configured to monitor an environment of the lighting device 1 and to send monitored information of the environment to the signal exchanging module 13. The signal exchanging module 13 is further configured to transmit the monitored information of the environment to the server 6 upon receipt of the same from the monitoring device 3. In such embodiments, the monitoring device 3 may be a camera located on top of the lighting module 12 and/or a microphone for receiving ambient sound. As a result, the monitoring device 3 can send the monitored information and image to the server 6 for monitoring purposes.

As illustrated in FIGS. 7 and 8, the environment detecting device 4 is electrically connected to the signal exchanging module 13 and to the first power converter 15 for receiving the DC power therefrom, and is configured to detect the environment of the lighting device 1 and to send detection information of the environment to the signal exchanging module 13. The signal exchanging module 13 is further configured to transmit the detection information of the environment to the server 6 upon receipt of the same from the environment detecting device 4. The detection information may include information related to an earthquake, air quality, rainfall, temperature, ultraviolet index, an inundation height, and movement of an object around the lighting device. In such embodiments, the environment detecting device 4 may be disposed at the pole 11. In certain embodiments, the environment detecting device 4 may be located in the lighting module 12 to measure the voltage, current, and power of the lighting component 122, and to send the measurement to the server 6 for recording and subsequent assessment. When the lighting component 122 exhibits abnormal activity, maintenance staff can be informed thereby and provides subsequent repair/maintenance.

As illustrated in FIGS. 7 and 8, the notification device 5 is electrically connected to the signal exchanging module 13 and to the first power converter 15 for receiving the DC power therefrom, and is configured to receive a notification and to send the notification to the signal exchanging module 13. The signal exchanging module 13 is further configured to transmit the notification to the server 6 upon receipt of the same from the notification device 5. In such embodiments, the notification device 5 may be disposed at the pole 11 and further includes a panic button 51. As an emergency situation occurs, passersby can press the panic button 51 to generate the notification, and then the notification device 5 can transmit the notification to the server 6 for calling assistance via the signal exchanging module 13.

Furthermore, an emergency alert, for example, related to an earthquake, a typhoon, or a tsunami, coming from the server 6 may be broadcasted by the wireless access device 2 of the lighting system 100 to the electronic device 7 within the coverage area, so as to notify a carrier of the electronic device 7 in a timely manner.

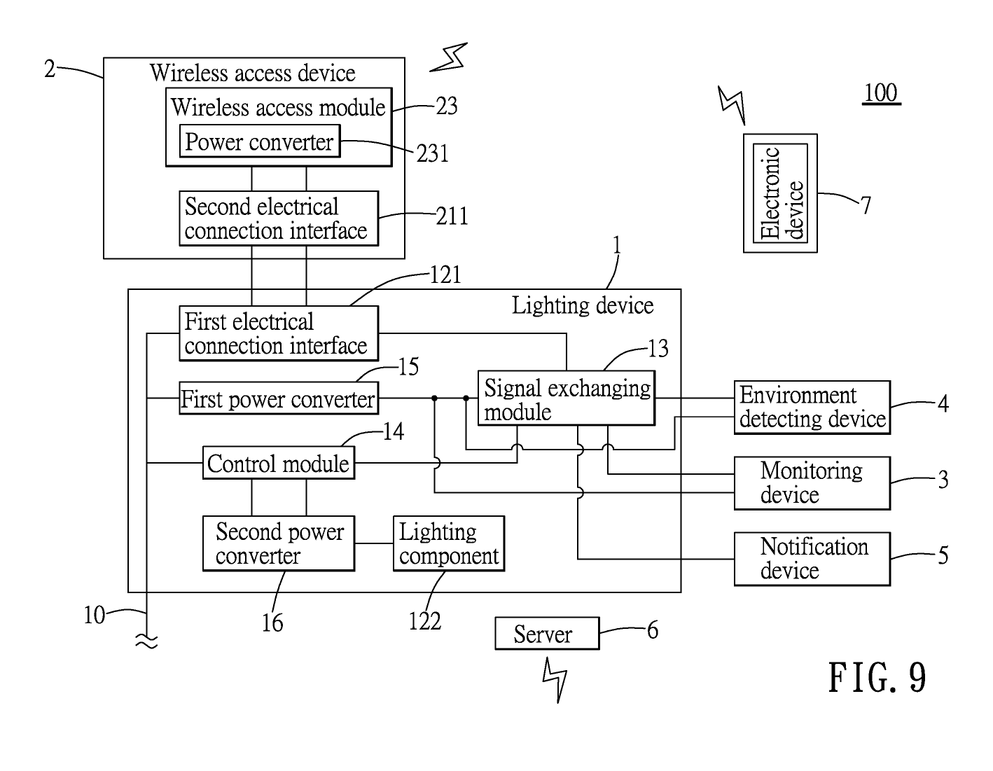

In certain embodiments, the wireless access module 23 of the lighting system 100 may be configured to wirelessly communicate with the server 6 via a wireless protocol as illustrated in FIG. 9, instead of via the physical signal line 61 as shown in FIG. 8. In such embodiments, the wireless protocol is suitable to be applied with a Subscriber Identity Module (SIM) card, and may include a Code-Division Multiple Access (CDMA) communication module. As a result, the lighting device 1 receives, by the wireless access module 23, the control signal from the server 6 which passes the first and second electrical connection interfaces 121 and 211 and arrives at the signal exchanging module 13. The control module 14 receives the control signal from the signal exchanging module 13 and controls the lighting component 122 accordingly. In certain embodiments, the wireless access module 23 can be disposed on a landscape lamp, i.e., the lighting device 1, and the server 6 sends the control signal to remotely control the lighting component 122 of the lighting device 1.

It may be worth noting that, the detection information of the environment from the environment detecting device 4, the monitored information from the monitoring device 3, and/or the notification from the notification device 5 can be transmitted via the signal exchanging module 13 through the first and second electrical connection interfaces 121 and 211 to the wireless access module 23, and then transferred wirelessly to the server 6. According to different requests, the detection information of the environment from the environment detecting device 4, the notification from the notification device 5, and/or the monitored information from the monitoring device 3 can be transmitted to the electronic device 7 by the wireless access module 23.

In summary, due to the relatively large coverage of the lighting device 1, combining the wireless access device 2 with the widespread lighting device 1 can not only effectively promote the coverage of wireless communication, but can also reduce the traffic load of the base stations from the ISPs. Also, by virtue of the full compatibility between the first and second electrical connection interfaces 121 and 211, it is convenient to combine the wireless access device 2 with the lighting device 1. Lastly, the lighting system 100 of the present disclosure can not only provide internet service to the electronic device 7 through the wireless access device 2 and the lighting device 1, but can also provide other functions like monitoring, environmental detection, and emergency notification in certain embodiments as described above.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A wireless access device configured to be electrically connected to a lighting device that communicates with a server, the wireless access device comprising:
a connecting base including an electrical connection interface configured to be directly and electrically connected to the lighting device and to receive electric power from the lighting device; and
wherein the wireless access device is configured to communicate with the server through the electrical connection interface and to receive the electric power from the lighting device through the electrical connection interface.

2. The wireless access device of claim 1, further comprising:
a housing connected to the connecting base and defining a receiving space;
a wireless access module disposed in the receiving space, electrically connected to the electrical connection interface, and configured to communicate with an electronic device and to allow the electronic device to communicate with the server; and
a cover removably connected to the housing for closing the receiving space.

3. The wireless access device of claim 2, wherein the wireless access module is a wireless access point.

4. The wireless access device of claim 3, wherein the wireless access module is a wireless router.

5. The wireless access device of claim 2, further comprising at least one antenna connected to and extending through the housing.

6. The wireless access device of claim 1, wherein the electrical connection interface includes a NEMA connector complying with ANSI C136 standards.

7. The wireless access device of claim 1, wherein the electrical connection interface includes a first plurality of pins configured to transmit the electric power, and a second plurality of pins configured to transmit data.

8. A lighting system capable of wireless communication, the lighting system comprising:
a lighting device configured to communicate with a server; and
a wireless access device including
a connecting base that includes an electrical connection interface directly and electrically connected to the lighting device and that is configured to receive electric power from the lighting device,
wherein the wireless access device is configured to communicate with the server through the electrical connection interface and to receive the electric power from the lighting device through the electrical connection interface.

9. The lighting system of claim 8, wherein the wireless access device further includes:
a housing connected to the connecting base and defining a receiving space;
a wireless access module disposed in the receiving space, electrically connected to the electrical connection interface, and configured to communicate with an electronic device and to allow the electronic device to communicate with the server; and
a cover removably connected to the housing for closing the receiving space.

10. The lighting system of claim 9, wherein the wireless access device further includes at least one antenna connected to and extending through the housing.

11. The lighting system of claim 8, wherein the electrical connection interface includes a NEMA connector complying with ANSI C136 standards.

12. The lighting system of claim 8, wherein the electrical connection interface includes a first plurality of pins configured to transmit the electric power, and a second plurality of pins configured to transmit data.

13. The lighting system of claim 8, wherein the lighting device includes:
a lighting component;
a signal exchanging module configured to communicate with the server and to receive a control signal from the server; and
a control module electrically connected to the signal exchanging module for receiving the control signal therefrom, and configured to control the lighting component in response to the control signal.

14. The lighting system of claim 13, further comprising an environment detecting device that is electrically connected to the signal exchanging module, and that is configured to detect an environment of the lighting device and to send detection information of the environment to the signal exchanging module,
wherein the signal exchanging module is further configured to transmit the detection information of the environment to the server.

15. The lighting system of claim 14, wherein the detection information includes information related to at least one of an earthquake, air quality, rainfall, temperature, ultraviolet index, an inundation height, and movement of an object around the lighting device.

16. The lighting system of claim 13, further comprising a monitoring device that is electrically connected to the signal exchanging module, and that is configured to monitor environment of the lighting device and to send monitored information of the environment to the signal exchanging module,
wherein the signal exchanging module is further configured to transmit the monitored information of the environment to the server.

17. The lighting system of claim 16, wherein the monitoring device includes one of a camera and a microphone for receiving ambient sound.

18. The lighting system of claim 13, further comprising a notification device that is electrically connected to the signal exchanging module, and that is configured to receive a notification and to send the notification to the signal exchanging module,
wherein the signal exchanging module is further configured to transmit the notification to the server.

19. The lighting system of claim 13, wherein the control module is further configured to send an error signal to the signal exchanging module when the lighting component exhibits abnormal activity, and the signal exchanging module is further configured to transmit the error signal to the server.

20. The lighting system of claim 8, wherein the wireless access device is further configured to communicate with an electronic device and to transmit a message from the server to the electronic device.

21. A lighting system capable of wireless communication, the lighting system comprising:
a lighting device; and
a wireless access device including
a connecting base that includes an electrical connection interface directly and electrically connected to the lighting device and that is configured to receive electric power from the lighting device,
wherein the wireless access device is electrically connected to the electrical connection interface for receiving the electric power therethrough and is configured to wirelessly communicate with a server.
